(19) United States
(12) Patent Application Publication
(10) Pub. No.: US 2006/0243119 A1
(43) Pub. Date: Nov. 2, 2006

(54) Online synchronized music CD and memory stick or chips

(76) Inventor: Gonzalo R. Rubang JR., Fairfield, CA (US)

Correspondence Address: Robert K. Tendler, 65 Atlantic Avenue, Boston, MA, 02110, US

(21) Appl. No.: 11/476,447

(22) Filed: Jun. 28, 2006

Related U.S. Application Data
(63) Continuation-in-part of application No. 11/015,782, filed on Dec. 17, 2004.

(51) Int. Cl. G10H 7/00; A63H 5/00; G04B 13/00

(52) U.S. Cl. 84/609

(57) ABSTRACT

A synchronized music delivery system utilizes either a portable memory device including compact discs (CDs), digital video discs (DVDs) and memory sticks, or on-line or wirelessly delivered content in combination with a lighted keyboard and a sound reproducing system. A synchronized musical work, including music, lyrics and specialized coding, is recorded onto the portable memory device or is stored on a server for on-line or wireless delivery, in one embodiment by downloading the information from the Internet to the portable memory device; and in another embodiment in a stand-alone version involving pre-recording the portable memory device. The stored synchronized music in one embodiment is provided with the actual song recording, sing-along words and including letters of the alphabet to be struck on a standard alpha-numeric computer keyboard, indicia, scrollable score coding incorporating notes on a musical score and fingering or a lighted key drive, all information being synchronized with the work. In one embodiment the synchronized memory device is inserted into a suitable slot in an electronic music synthesizer having a lighted keyboard and song reproduction equipment such that a virtually unlimited number of musical works can be readily delivered in one embodiment to a CD ROM/DVD burner over the Internet, whereby not only can a karaoke-like audio-visual experience be provided, but also a synchronized lighted keyboard is provided to enable an individual not only to sing along, but to play along with the work.

### RELATED APPLICATIONS

This Application is a continuation-in-part of co-pending U.S. application Ser. No. 11/015,782 filed Dec. 17, 2004, the contents of which are incorporated herein by reference.

### FIELD OF THE INVENTION

This invention relates to music delivery systems and more particularly to the provision of a virtually unlimited supply of musical works via the Internet or wirelessly for downloading to a synchronized music system including a keyboard actuated music synthesizer.

### BACKGROUND OF THE INVENTION

It will be appreciated that those seeking to make music have been provided in the past with karaoke systems in which music lyrics are provided in a so-called bouncing ball display, along with the actual music that is audibly reproduced. The individual is induced to sing along with the music as it is reproduced so as to provide a pleasing experience for the individual.

Additionally, lighted music keyboards from Yamaha, Casio and others have provided a graphical display of a bar of music along with a display of fingering necessary to provide the music on a keyboard. The fingering indicia and the notes on the bar, when displayed in conjunction with the lyrics, cause various keys on the keyboard to be illuminated.

These musical systems incorporating music synthesizers and the like are provided with pre-programmed musical works, including music and lyrics, which does not provide the individual with a wide range of musical works or repertoire. As is the case with the present Yamaha units, one can learn to play or provide a karaoke experience with only a selected small number of musical works due to the limited storage of the keyboard or synthesizer.

Casio, on the other hand, provides the drive for their lighted keyboard synthesizer from a so-called smart card. However, the problem with smart cards is that they are limited to 80 K-bytes, which severely limits the amount of information that can be stored.

It is noted that neither the internal memory storage of a synthesizer nor the capability of a smart card is sufficient to provide for multiple songs, much less his ability to download a synchronized CD/DVD from the Internet. Moreover, such equipment does not provide any kind of video production.

The result is that there is only a limited library of musical works adapted for lighted keyboards that can be used as teaching or prompting tools based on the current technology employed within music synthesizers.

### SUMMARY OF INVENTION

In order to accommodate the need for an almost unlimited amount of musical works adapted to lighted keyboard synthesizers, in the subject invention musical works are captured and are reformatted either at a central server or to a portable memory device such as a memory stick, iPod, MP3 player, music CD or DVD that includes information relating to synchronizing the lighted keyboard with the program material. In one embodiment of the subject invention, the producer of the synthesized music records the actual song recording or track on the portable memory device or at the server. The memory device or server is also provided with the lyrics in terms of a sing-along format synchronized to the song recording. The producer also encodes information to be able to generate a traveling or scrolling score display. Note, in one embodiment, the display for presenting the score displays the notes, along with fingering. In another embodiment used with personal computers, a letter or number is displayed below a word in the song. This alerts the individual what keyboard key to finger and when. The traveling or scrolling score uploaded to the display is likewise synchronized with the actual song recording and the sing-along lyrics.

Finally, the synchronized music is either stored at a server or portable memory device and provided with coding that will drive the lighting of the keyboard of the synthesizer, also synchronized to the actual song recording, the lyrics and the scrolling score display, so that when the coded program material is inputted to the music synthesizer and/or music reproduction system, the individual can either sing and play along with the song as it is depicted on the scrolling score, or the individual can be taught how to play the song based on the lighted keyboard or the keys to be pressed.

In one embodiment, underneath each word of a song is a letter corresponding to the letters on a standard keyboard. This obviates the need for a lighted keyboard and permits use of a standard computer. Secondly, while the Internet offers one transmission system for transmitting the coded music to the music synthesizer, wireless transmission over 802.11 and wireless handset frequencies provides for the coded program material to be installed on the synthesizer. Also, MP3 players and iPods may provide a source of the coded work to the synthesizer. Moreover, satellite communications channels such as a SIRIUS or XM Radio may be used to wirelessly transmit the coded program material.

Finally, the synthetic music synthesizer need not be a standalone unit, but can be a computer with a keyboard, with the music generated by software in the computer and outputted to a MIDI audio file for reproduction.

When CDs or DVDs are used, what is advantageous for the subject system is the fact that an individual can burn his or her CDs or DVDs locally from his or her computer, with the synchronized music CD or DVD having been produced off-line and supplied over the Internet.

What this means is that a wide variety of musical works can be produced at one location and formatted into a synchronized memory stick, CD or DVD format by a music provider or distributor, with the music and synchronized cues or prompts being distributed over the Internet so that the individual seeking to have this musical experience is induced to download the information to a stick or to burn the CD or DVD using the individual's CD or DVD burner, whereupon the portable memory device may be inserted into the music synthesizer.

The result is that individuals can be provided with enhanced karaoke experience that involves more than simply a sing-along, but can rather be provided additionally with a lighted keyboard or letters to strike to enable the person not only to sing along but also to play along. Moreover, one can also display the musical work in synchronism with the audio for whatever audio-visual entertainment purposes may be desired.

For instance, the particular work may include a music video, which is projected onto a large screen, along with a bouncing ball lyrics drive, while at the same time actuating the lighting system for the illuminated keyboard, whether or not a display of the musical score is used. Thus, the synchronized work stored either on a server or on the portable memory device can be used to provide all of the prompting functions.

Key, however, to one embodiment of the subject invention is the provision of the synchronized music portable memory device having a lighted key drive coding system that causes the keys to be illuminated as the work is performed. The illumination of the keys alone may be enough to cue the individual to play the correct notes on the keyboard, whereas the display of the traveling sheet or score may further aid the individual in playing the correct notes.

In another embodiment, keyboard letters appear on the music scroll to indicate which computer keyboard key is to be pushed.

If the individual seated at the keyboard is to sing, then the display at the keyboard may be adapted to provide for the bouncing ball lyric display described above. Also the actual song recording may be reproduced at the site at the user's election.

While one aspect of the subject invention will be described in connection with CDs or DVDs, it is understood that any portable memory device of sufficient capacity can be used.

In summary, a synchronized music delivery system utilizes either a portable memory device including compact discs (CDs), digital video discs (DVDs) and memory sticks, or on-line or wirelessly delivered content in combination with a keyboard, lighted or not, and a sound reproducing system. A synchronized musical work, including music, lyrics and specialized coding, is recorded onto the portable memory device or is stored on a server for on-line or wireless delivery, in one embodiment by downloading the information from the Internet to the portable memory device; and in another embodiment in a stand-alone version involving pre-recording the portable memory device. The stored synchronized music in one embodiment is provided with the actual song recording, sing-along words and including letters of the alphabet to be struck on a standard alphanumeric computer keyboard. Indicia and a scrollable score coding incorporating notes on a musical score and fingering or a lighted key drive are provided such that all information is synchronized with the work. In one embodiment the synchronized memory device is inserted into a suitable slot in an electronic music synthesizer having a keyboard and song reproduction equipment such that a virtually unlimited number of musical works can be readily delivered in one embodiment to a computer over the Internet, whereby not only can a karaoke-like audio-visual experience be provided, but also in one embodiment a synchronized lighted keyboard is provided to enable an individual not only to sing along, but to play along with the work.

### BRIEF DESCRIPTION OF THE DRAWINGS

These and other features of the subject invention will be better understood in connection with a Detailed Description, in conjunction with the Drawings, of which:

FIG. 1 is a diagrammatic illustration of the subject system in which a synchronized music CD or DVD is burned from a download to his computer, with the synchronized music CD or DVD being inserted into an appropriate slot in a lighted keyboard music synthesizer;

FIG. 2 is a diagrammatic illustration of the display of the lighted keyboard synthesizer of FIG. 1, illustrating the lyrics on the top portion of the display being cued by a bouncing ball technique, with the particular note to be played displayed directly underneath the particular word in the lyric, and optionally with fingering for the finger to play the keyboard also being synchronized with the musical work and lyrics;

FIG. 3 is a diagrammatic illustration of a lighted keyboard for use in the electronic music synthesizer of FIG. 1, illustrating the lighting of a key corresponding to Middle C;

FIG. 4A is a diagrammatic illustration of an individual seated at the keyboard of FIG. 1, in which a score is displayed and in which keyboard keys are illuminated indicating the playing of a chord such as C Major;

FIG. 4B is a diagrammatic illustration of a number of musicians accompanying the individual using the synchronized music CD/DVD-driven synthesizer of FIG. 1;

FIG. 5 is a diagrammatic illustration of a flow chart illustrating the production of a musical work, the production of a synthesized music CD/DVD, the readout of the synchronized music CD/DVD to the Internet where it is downloaded by a computer, with the computer being used to burn a CD or DVD that is inserted into a suitable slot in the music synthesizer and/or song reproduction system, and with the synchronized music CD/DVD providing a synchronized song recording, lyrics and indicia, scrolling score display coding, and lighted keyboard drive coding;

FIG. 6 is a diagrammatic illustration of a computer as a music synthesizer, showing both wireless and wired content delivery systems as well as content provided on a memory device;

FIG. 7 is a diagrammatic representation of a synthesizer keyboard with a display, with the coded contents provided wither by a CD or DVD disc, or an MP3 or iPod player; and,

FIG. 8 is a diagrammatic representation of the wireless transmission of content through the use of cell phones and other wireless devices coupled to a computer or video game device.

### DETAILED DESCRIPTION

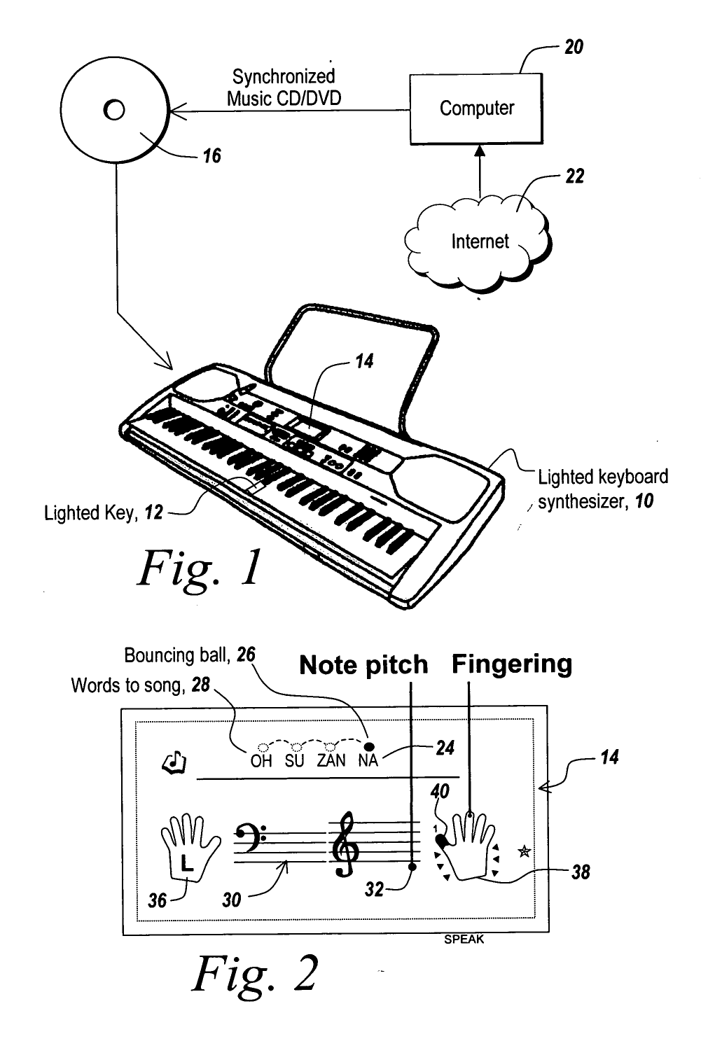

Referring now to FIG. 1, a lighted keyboard synthesizer 10 is provided with a lighted key 12 that indicates to an individual which key to depress in order to provide a particular sound or tone. Synthesizer 10 is provided with a display 14, positioned in front of the individual playing the keyboard, which provides the individual with a display of the lyrics to be performed, a score, and alternatively a fingering diagram to indicate to the individual what finger or fingers he or she is to use in order to play the musical work.

Rather than having an internally stored program that is of limited capacity, an almost unlimited number of songs or musical compositions or works may be loaded into synthesizer 10 through the use of a synchronized music CD/DVD 16 that is either store-bought or burned on a CD ROM or DVD burner that is part of a computer 20 coupled to the Internet 22.

Because of the storage capacity of either the compact discs or the DVD discs, it is possible to store multiple works.

In one embodiment and referring to FIG. 2, display 14 may display lyrics 24 in a scrolling display. It may provide bouncing ball indicia 26 to indicate to the individual during the playing of the particular work the words 28 to be sung.

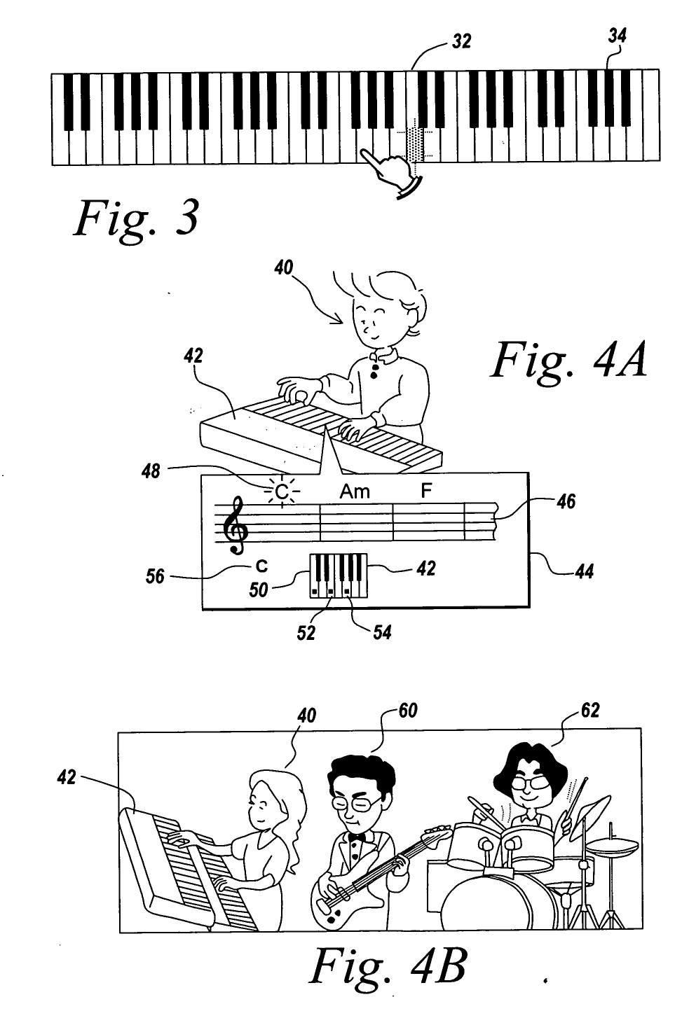

Underneath the scrolling lyrics is a score 30, which has on it at least one note 32 that is depicted immediately below the word in the song corresponding to the particular note to be played. The note to be played causes a key to be lighted, such as illustrated in FIG. 3 by key 32 of keyboard 34. In this manner not only is a karaoke function available with the display of the lyrics and a scrolling score display, but also the note to be played is presented to teach an individual how to play a particular song or to cue the individual for the particular song involved so that his rendition of the song, either verbally or by playing the keyboard or both, may be enhanced or may correspond more closely to the work itself.

As illustrated, a person's left hand 36 and a person's right hand 38 may be displayed on display 14 along with the finger 40 that is to be used.

All of the information is carried by the synchronized music CD/DVD so that all of the above functions may be synchronized together when the CD or DVD is played.

Referring now to FIG. 4A, an individual 41 seated at a lighted keyboard 42 is provided with a display 44 of a score 46, with the individual prompted to play a chord. The chord is indicated by indicia 48, and the lighting of the appropriate keys.

Referring now to FIG. 4B, when individual 40 is in front of his or her keyboard and seeks to play with a band generally having musicians 60 and 62, the individual's play can be improved by virtue of prompting provided by the lighted keyboard. The repertoire of the band is enhanced by virtue of the fact of the virtually unlimited number of works that can be downloaded to the individual's computer, which makes practicing a wide variety of songs easy and use of the lighted keyboard during a performance can actually enhance the performance.

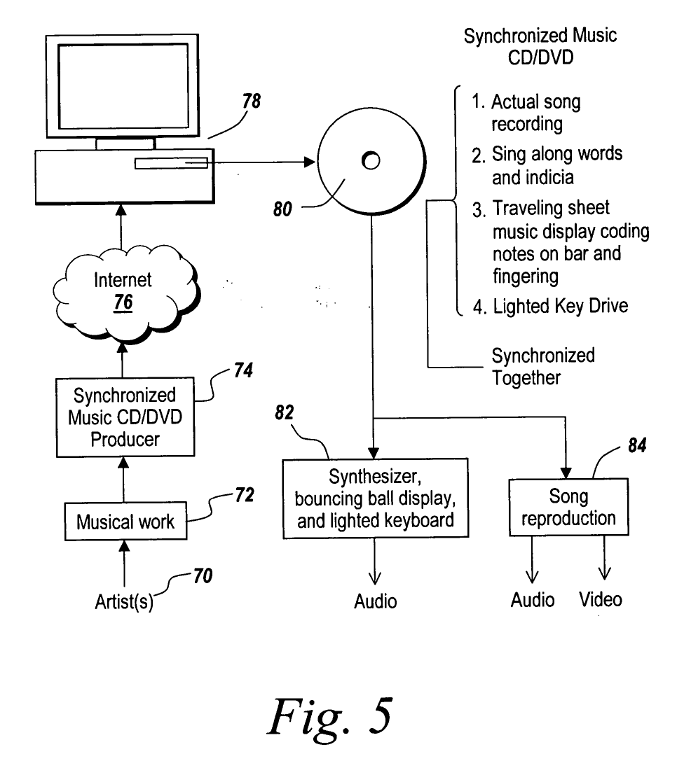

Referring now to FIG. 5, in one embodiment an artist or artists 70 produce a musical work 72, which is converted by a synchronized music CD/DVD producer 74 into various tracks of synchronized music information. The producer then offers the synchronized music CD or DVD over the Internet 76, which is coupled to an individual's computer 78.

When the individual seeks to perform a large number of songs, he or she burns a CD or DVD 80, which is inserted into a music synthesizer/karaoke machine 82 that provides, for instance, the lighted keys mentioned above as well as a bouncing ball lyric display. The CD may also drive an audio reproduction system 84, which outputs audio corresponding to the particular song, as well as, optionally, a video that is likewise synchronized to the work.

What will be see is that, whether providing a CD or a DVD, the information encoded on the device is capable of driving the lighted keyboard of the synthesizer, the lyric and score display while at the same time driving audio and visual outputs to facilitate karaoke. Also, a music-minus-one function may be accomplished in which that which is produced audibly or visually is the work minus the performer, with the audio and/or visual provided by the individual being blended with that which is produced by the other artists so that the artist is inserted into the band or orchestra.

What is therefor provided by the subject system is a synthesized music CD/DVD distribution system in which an extremely large library of songs can be properly encoded with synchronized tracks for driving the lighted keyboard and/or display of the synthesizer. This therefore transcends the limited abilities of those synthesizers which are pre-programmed or which use smart card techniques. Moreover, if every music CD or DVD is provided with the appropriate tracks or information, then individuals performing such works along with the music will be provided with an invaluable teaching aid or prompting tool.

While the above invention has been described in terms of downloading synchronized music memory sticks, CDs or DVDs from the Internet, it is within the scope of this invention for the music producer to manufacture the synchronized music memory sticks, CDs or DVDs themselves. For CDs and DVDs the distribution system would be similar to that by which normal music CDs or DVDs are distributed, with the advantage being that they can be inserted into an appropriate lighted keyboard-based synthesizer so that not only can the individual sing along with the music but also use the keyboard to perform the music. This gives additional functionality to the rather limited offerings of the present synthesizers and keyboards to provide the individual with a virtually limitless supply of karaoke-type and music-minus-one-type works to be practiced and performed.

### The Computer As a Synthesizer

While the system described above utilizes a standard synthesized keyboard and while it is possible to provide an overlay on a computer keyboard and light it in the same way as a synthesizer keyboard, it is also possible to assign chord groups or notes to individual keys on a computer keyboard. Thus, rather than providing a keyboard overlay that approximates a piano keyboard, one can generate or synthesize the music by depression of the individual keys on the standard computer keyboard.

Of course, once having generated the synchronized music work utilizing the voice of a particular singer, because the singer's voice along with the musical work is stored in the computer it may be downloaded, for instance, to an email address or cell phone. Moreover, the saved work can be recorded onto a music CD, a memory stick, an MP3 device or an iPod. Also, the performance can be saved or moved to various file folders or email dialogue boxes.

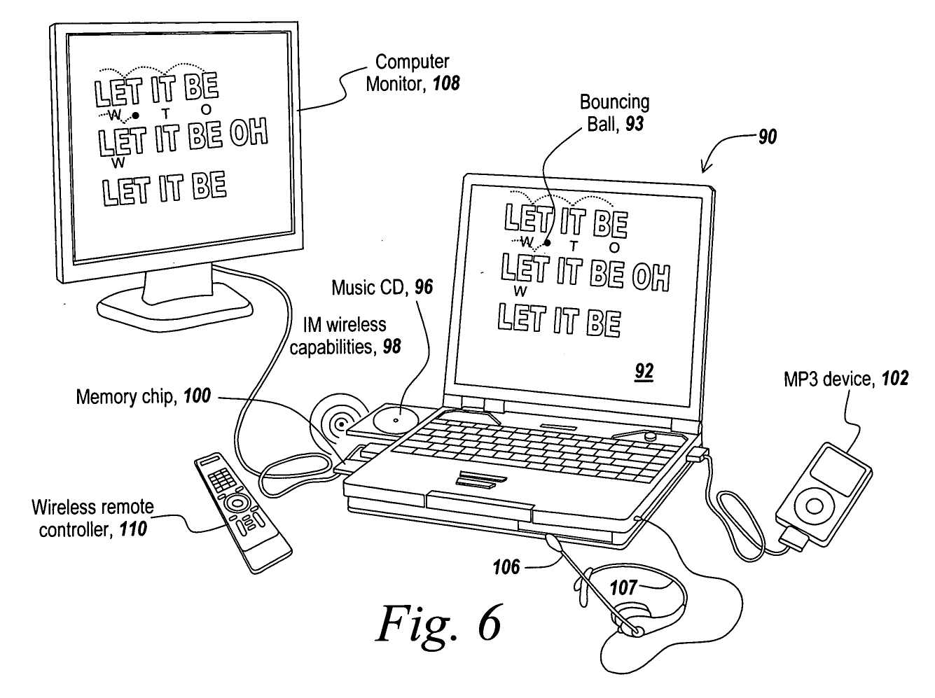

As will be seen and referring to FIG. 6, a laptop computer 90 is provided with the words to a song on its screen 92 on which underneath the words is one or more alphanumeric symbols corresponding to the alphanumeric key on a computer keyboard.

Here it can be seen that computer keyboard 94 has the letter “W,” a bouncing ball 93, the letter “T” and the letter “O.”

Assuming that computer 90 has been loaded with the synthesized music coded structure and if this coded structure includes alphanumerics underneath the song words, then one could use the standard PC to generate notes, chords or the like.

The use of a PC is convenient because the coded content can be delivered to the personal computer either by the aforementioned music CD 96 or by wireless connection 98, such as by using 802.11 or even through the use of cell phones. As before, in addition to the CD one can use a memory chip 100 for storing the coded program material into the computer.

In practice, in an on-line process a surfer hits an on-line synthesized music CD, SMCD icon, button or key to allow the individual to surf the net and select songs to save or buy which have been appropriately formatted. The downloaded coded songs are then presented by the computer both audibly and with a lighted keyboard or by the presentation of letters indicating the keys to be depressed. While the on-line process is initialized by the pressing of the on-line SMCD key, with a press of this key the computer is returned to normal operation.

In addition to providing the coded program material from pre-recorded CDs or memory media, and in addition to transmitting the coded content over a wireless link, an MP3 device or an iPod 102 may be loaded with the coded content either by connection to the Internet or by wireless connection to the device.

Note that song publishers will be able to set up servers to sell synchronized CDs on-line for all of their music, making the synchronized CDs readily available. Keeping track of the downloads provides a metric for success as well as providing a billing vehicle.

As an added feature, music publishing houses can print jingle magazines or lyric magazines that would provide assistance to computer keyboard players to play and sing along, with the magazines presenting the appropriate keyboard letters below the lyrics in the same manner as they are presented on-screen by the subject system.

Note that a headset 104 with a boom mike 106 is used to provide the audio input from the individual singing the song. Also, the plugging in of the headset can provide a so-called silent or quiet mode by disconnecting the computer's speakers so as to not unduly disturb people in the area.

Additionally, a computer monitor 108 of any size may be driven by computer 90, with the screen being controlled by a wireless remote controller 110.

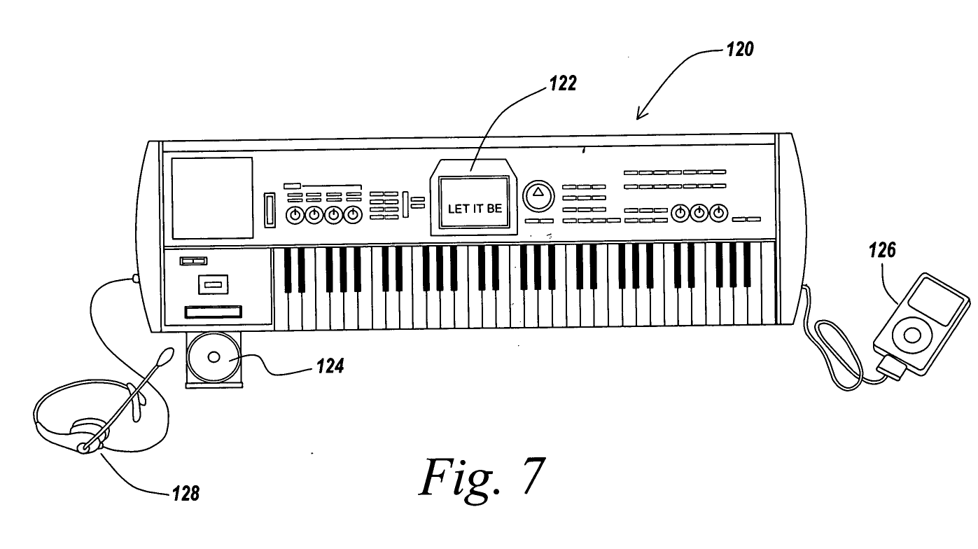

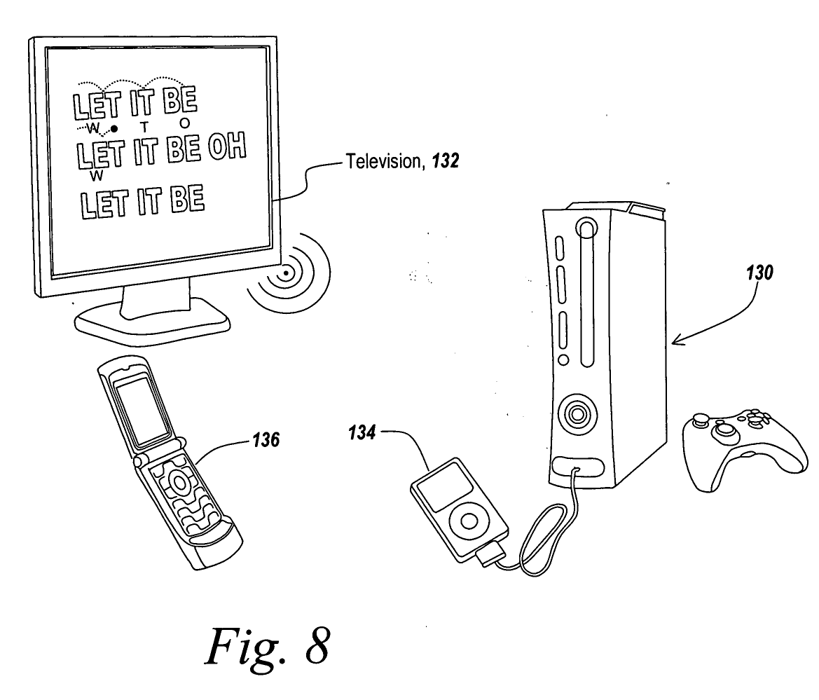

Referring now to FIG. 7, a synthesizer keyboard 120 may be provided with a display 122 and may have the coded content provided either by a CD ROM disc or a DVD disc 124; or the coded content may be provided by an MP3 device 126 or by an iPod. Since the MP3 devices and iPods are popular and since songs are regularly downloaded to these devices over the Internet, it is relatively easy to plug in the MP3 device into synthesizer 120 and to provide the synthesizer with a headset and microphone 128 so as to amplify the individual's voice performing the song as well as to capture the performance, for instance on the MP3 device 126.

Referring to FIG. 8, there are a number of both handheld and standalone devices that are used in playing games such as video games. Here a video game system 130 such as an XBox may be used to wirelessly drive a television 132 or other appropriate display. The coded content may be provided by an MP3 device 134, or the content can be loaded into the video game system in the manner described above using memory devices.

Finally, cell phones 132 may be used as the repository for the coded content and may use Bluetooth or other wireless techniques to download the stored content to a synthesizer, computer or video game system.

In summary, the synthesized music content can be provided on any of a number of memory media or can be delivered in streaming audio and other techniques over the Internet directly to a computer or synthesizer that has a keyboard. In one embodiment it is not necessary to light up the keyboard but rather to provide the on-screen song words with keyboard letters and by providing with the coded program material that the computer act as a music synthesizer to play notes corresponding to the keyboard keys depressed.

While the present invention has been described in connection with the preferred embodiments of the various figures, it is to be understood that other similar embodiments may be used or modifications or additions may be made to the described embodiment for performing the same function of the present invention without deviating therefrom. Therefore, the present invention should not be limited to any single embodiment, but rather construed in breadth and scope in accordance with the recitation of the appended claims.

What is claimed is:

1. A method for enabling synchronized music works to be used with a computer, comprising the steps of:
coupling a lighted keyboard to the computer;
producing a synchronized music work including an audible track and coding for activating the lighted keyboard;
downloading the synchronized music work to the computer;
using the computer to reproduce the synchronized music work audible track so as to produce audible music; and,
activating the lighted keyboard in accordance with the lighted keyboard coding such that an individual can play one or more synthesized notes by depression of a lighted key in synchrony with the reproduced audible track.

2. The method of claim 1, wherein the producing step includes storing the produced synchronized music work on an Internet server; and wherein the downloading step includes downloading the synchronized music work from the Internet server.

3. The method of claim 1, wherein the synchronized music work includes information relating to song lyrics.

4. The method of claim 3, and further including the step of displaying the song lyrics.

5. The method of claim 4, and further including the step of displaying an alphanumeric symbol adjacent a lyric corresponding to the keyboard key to be depressed.

6. The method of claim 1, wherein the synchronized music work includes information relating to the production of a scrollable score incorporating the notes involved in the synchronized music work.

7. The method of claim 1, wherein the synchronized music work includes information relating to sing-along words and indicia to indicate what word should be sung at what time.

8. The method of claim 1, wherein the computer has a display and further including the step of prompting the individual to sing the song based on the prompting.

9. The method of claim 8, and further including the step of recording the voice of the individual as the individual sings the song prompted by the computer.

10. The method of claim 9, and further including the step of downloading the recorded song to a digital medium.

11. The method of claim 10, wherein the digital medium includes a digital video disc.

12. The method of claim 10, wherein the digital medium includes a memory stick.

13. The method of claim 10, wherein the digital medium includes an iPod.

14. The method of claim 10, wherein the digital medium includes a thumb drive.

15. The method of claim 10, wherein the digital medium includes an MP3 player.

16. A method of enhancing the performance of a computer to permit the playing of a virtually unlimited number of musical works in which keys on the keyboard of the computer are to be depressed in accordance with notes to be played corresponding to the musical notes of the work, comprising the steps of:
configuring the computer as a music synthesizer;
providing a downloadable synchronized music work including an audible track and having coding synchronized to the audible track to indicate the keys of the computer keyboard to be depressed;
downloading the work to the computer; and,
indicating the keys on the keyboard to be depressed in accordance with the work while reproducing the audible portion of the downloaded work, whereby an individual using the computer as an electronic music synthesizer may play notes using the keyboard in synchronism with the audio reproduction of the work.

17. The method of claim 16, wherein the computer includes a display of lyrics and an indication of what words of the lyrics are to be sung, and wherein the synchronized music work includes coding to establish the lyrics to be displayed on the display and an indication of what words are to be sung at what time.

18. The method of claim 16, and further including the step of singing the lyrics displayed, detecting and amplifying the sung lyrics and combining the amplified song lyrics with the audible track and the notes played by depressing keys on the keyboard.

19. The method of claim 16, and further including the step of activating an on-line song application for the download of a synthesized music work and returning the computer to normal use after the on-line song application is no longer required.

20. A method for enabling synchronized music works to be used with a computer, comprising the steps of:
coupling a keyboard to the computer;
producing a synchronized music work including an audible track and coding for indicating what keys on the keyboard should be depressed and at what time;
downloading the synchronized music work to the computer;
using the computer to reproduce the synchronized music work audible track so as to produce audible music; and,
indicating from the coding which keyboard keys should be depressed such that an individual can play one or more synthesized notes by depression of a key in synchrony with the audible track.

21. The method of claim 20, wherein the producing step includes storing the produced synchronized music work on an Internet server; and wherein the downloading step includes downloading the synchronized music work from the Internet server.

22. The method of claim 20, wherein the synchronized music work includes information relating to song lyrics.

23. The method of claim 22, and further including the step of displaying the song lyrics.

24. The method of claim 23, and further including the step of displaying an alphanumeric symbol adjacent a lyric corresponding to the keyboard key to be depressed.

25. The method of claim 20, wherein the synchronized music work includes information relating to the production of a scrollable score incorporating the notes involved in the synchronized music work.

26. The method of claim 20, wherein the synchronized music work includes information relating to sing-along words and indicia to indicate what word should be sung at what time.

27. The method of claim 20, wherein the computer has a display and further including the step of prompting the individual to sing the song based on the prompting.

28. The method of claim 27, and further including the step of recording the voice of the individual as the individual sings the song prompted by the computer, the audible track and the synthesized notes corresponding to keyboard key depression, thus to record a completed song.

29. The method of claim 28, and further including the step of downloading the completed recorded song to a digital medium.
